(19) United States
(12) Patent Application Publication
(10) Pub. No.: US 2015/0202107 A1
(43) Pub. Date: Jul. 23, 2015

(54) AIR PURIFICATION SYSTEM FOR OPERATING THEATRES

(71) Applicant: Mohsin Ali KHAN, Uttar Pradesh (IN)

(72) Inventor: Mohsin Ali Khan, Lucknow (IN)

(21) Appl. No.: 14/422,004

(22) PCT Filed: Mar. 13, 2013
(86) PCT No.: PCT/IN2013/000166

§ 371 Date: Feb. 17, 2015

(30) Foreign Application Priority Data
Aug. 17, 2012 (IN) 2552-DEL/2012

(51) Int. Cl. A61G 13/10; B01D 53/14; B01D 53/00

(52) U.S. Cl. CPC A61G 13/108; B01D 53/007; B01D 53/1493; B01D 2252/103

(57) ABSTRACT

This invention relates to an air purification method comprising of sucking fresh air into a bed of liquid to absorb impurities followed by dehumidifying the fresh air leaving the bed of liquid and then pushing the fresh air to the desired facility for being used by user/s of the facility and finally ventilating out the used air from the desired location.

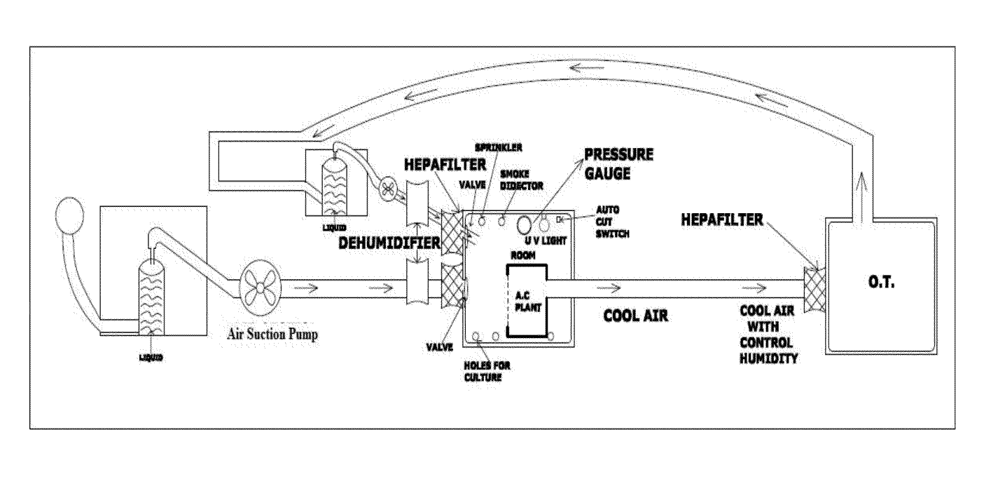

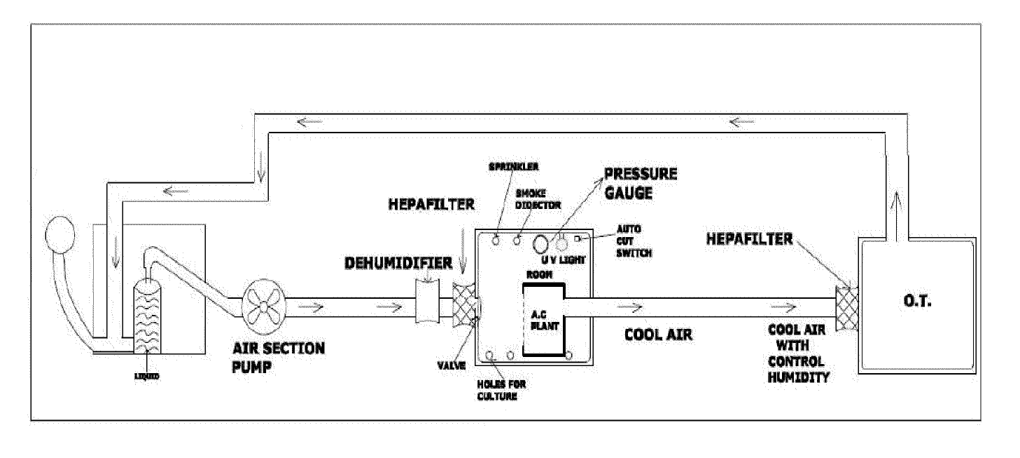

### FIELD OF THE INVENTION

The present invention relates to higher level of air purification required in operation theatres, intensive care units, Mortuary Room, Maternity Ward, Pharmaceutical Labs, Bio safety Labs, Paint shops and other critical areas where we have to arrest the concentration of airborne contaminants like virus, bacteria and DNA etc. damaging particulates. The invention is a unique system where air is passes through multi level purifications to insure a high level of purity, upto 0.2 micron.

### BACKGROUND OF THE INVENTION

The air purification system is of utmost importance in hospitals, laboratories, operations theatres etc. As we all know, infectious diseases can be spread by the transfer of viruses and bacteria, not only by direct and indirect contact, but also through the air. Germs can be disseminated through the air by droplet transmission or by airborne transmission, with colds and flu typically spread by both means. Pneumonia, scarlet fever, mumps, rubella and meningitis are diseases that are typically transmitted through larger droplets expelled as an infected person breathes, speaks, coughs or sneezes. Depending on their size, droplets can travel through the air for 3 to 6 feet before falling to the ground. In these cases, close contact with someone who is infected is necessary to become ill. Tuberculosis, chicken pox, shingles and measles are among the diseases that are transmitted in this way. These diseases are carried through the air by smaller particulates, for example, by dust particles, or by smaller droplets formed when larger droplets evaporate or are aerosolized. These tiny particles hang in the air like invisible smoke and can travel on air currents and through ventilation systems over considerable distances. At present air purification at industrial level is done through HEPA Filters, which purifies air upto 99.7% while Viral outbreaks have shown the importance of proper air purification, we have to seek for better and more efficient methods of air purification.

Basically air purification is being carried out by filtration, irradiation, using adsorption by activated carbon, using electronically enhanced media, photocatalytic oxidation, ionisers and other techniques, while all of these techniques efficient, yet there is a continuous need in industry to get much more filtered air and that's too at an economic and convenient mode of maintenance. So far surveys tell us that although filtration of air through HEPA filters is most applied filtration method in industry, still there is a need to get much more purified air. And other hurdle that users faces while using HEPA filtration method for air purification is its maintenance cost, which includes frequent cleaning of filters and routine replacement of filter cartridges.

Objective of this research is to generate a filtration method with much more filtration efficiency and to reduce maintenance cost of HEPA filter based filtration methodology.

Our invention is primarily focused on enhancing air quality with a level of higher purification with respect to HEPA filters using a new invented technique of Air sucked filtration

Second objective of our invention is reducing the cost of maintenance of HEPA filter by increasing time interval between replacements and changing of HEPA filters cartridges.

### SUMMARY OF THE INVENTION

The present invention deals with an air purification method comprising
sucking fresh air into a bed of liquid to absorb impurities,
dehumidifying the fresh air leaving the bed of liquid,
pushing the fresh air to the desired facility for being used by user/s of the facility;
ventilating out the used air from the desired location.

In one of the embodiment, the air purification method comprises passing the fresh air through HEPA filter/s after dehumidifying the fresh air. It also comprises purifying the fresh air through Ultraviolet light before pushing the fresh air to the desired facility.

In a further embodiment, the air purification method comprises the process of ventilating out the used air from the desired location to a recycling unit; and filtering the used air by the recycling unit. The used air is filtered using water mixed with chemicals.

In an alternate embodiment, the air purification method comprises dehumidifying the used air after filtering and pushing the recycled air to the desired facility. It also comprises passing the used air through HEPA filter/s after dehumidifying and before pushing into the desired facility.

The present invention is also represented as an air purification system comprising:
a suction pump adapted to suck fresh air into a bed of liquid to absorb impurities;
a dehumidifier adapted to dehumidify the fresh air leaving the bed of liquid;
an AC plant adapted to push for sucking the fresh air from dehumidifier after dehumidification and to push the fresh air to a desired facility for being used by user/s of the facility; and
a ventilator adapted to ventilate out the used air from the desired facility.

One of the embodiments of the air purification system comprises an HEPA filter for purifying the fresh air after dehumidifying the fresh air.

A further embodiment of the air purification system comprises a ultra violet ray producer adapted to produce ultraviolet ray and to pass the ultraviolet rays through the fresh air through the AC plant before directing the fresh air to the desired facility.

In yet another embodiment, the air purification system comprises a recycling unit adapted to receive used air after being ventilated out of the desired location and to filter the used air. The recycling unit is adapted to filter the used air by passing the used air through water mixed with chemicals.

### DETAILED DESCRIPTION ABOUT THE INVENTION

The process involves fresh air supply as well as purification of recycled air. Fresh air is supplied to liquid where with the help of chemical and ultra violet rays the level of germs and bacteria is reduced.

Air is sucked through water by an air suction pump. This air is then then dehumidified and passed to HEPA filter to ensure its purification at second stage. After 2 stage of purification this air is supplied to AC Plant where before entering into the AC plant it is again purified with Ultra Violet rays. Through AC plant air is forced to desired facility. After entering at desired facility air is ventilated to recycling unit where this air is recycled and is passed through water mixed with chemical via a washable duct. Then fresh air and recycled air both are passed through the same procedure of dehumidification, HEPA filtration and UV purification. Quality and volume of air is monitored in AC Plant.

### Basic Design:

Our filtration plant contains suctions pumps to suck air through water and chemicals, HEPA filters to filter air after sucking it through suction pumps, AC plant which purifies air by UV purification method, it also monitors air quality and finally controls air volume.

### Process Flow:

Process of purification in this project is described in two classifications one is Air flow and second as Control

Air Flow will take in 8 steps in this process these steps are:
Step 1: Fresh air is purified by initially passing it through a bed of liquid. This bed of liquid will absorb impurities and pass purified air. In this step air is sucked from atmosphere through a bed of water by a suction pump of rating 1 HP with 14-40 rpm speed and power consumption of 650 watt.
Step 2: As air after passing through bed of liquid will contain humidity so it is dehumidified through dehumidifier in this step.
Step 3: This dehumidified air is further purified by passing it through conventional HEPA filters. As air is already purified with water so HEPA will work as secondary mode of air purification. This will reduce substantial efforts on replacement of HEPA filters, thus reducing maintenance and replacement cost of HEPA filtration method and making the whole system cost effective and maintenance economic.
Step 4: Outlet of HEPA filter will be in AC plant. AC plant will store air for suction of AC. In this chamber air is again purified through UV light, as a tertiary air purification method.
Step 5: In AC plant, AC will suck this air and will discharge this air in desired location.
Step 6: Discharge of used air will be done through vent ports by ventilation fans.
Step 7: This discharged air will be sent to a separate unit for recycling, This recycling unit will have a separate setup for recycling air through suction method. Used air in recycling plant will be passed through water mixed with chemical via a washable duct and will be sucked again by suction pump.
Step 8: This recycled air is then sent for dehumidification and then to HEPA filters. After dehumidification and filtration this air is sent to AC unit along with fresh air.
Step 9: Air Quality and volume Control through AC plant:

### Quality Control:

AC Plant will take care of quality control of air through quality control mechanism. It will be done as per requirement of user. Active sampling or automatic sampling method for air quality measurement can be implemented after analysing need and budget of user.

Volume Control: AC Plant will control quality of air through self-retracting valves which will work on pressure difference

Auxiliaries and mode of operation of AC Plant:

### Other Accessories:

This chamber support following accessories for purification process
1. Inlet Valves
2. Sprinklers
3. Pressure gauge setup
4. UV Light setup
5. Auto cut Mechanism
6. Smoke detector

I claim:

1) An air purification method comprising:
sucking fresh air into a bed of liquid to absorb impurities,
dehumidifying the fresh air leaving the bed of liquid,
pushing the fresh air to the desired facility for being used by user/s of the facility;
ventilating out the used air from the desired location.

2) The air purification method according to claim 1 comprises passing the fresh air through HEPA filter/s after dehumidifying the fresh air.

3) The air purification method according to claim 1 comprises purifying the fresh air through Ultraviolet light before pushing the fresh air to the desired facility.

4) The air purification method according to claim 1 comprises:
ventilating out the used air from the desired location to a recycling unit; and
filtering the used air by the recycling unit.

5) The air purification method according to claim 4 comprises filtering the used air using water mixed with chemicals.

6) The air purification method according to claim 5 comprises dehumidifying the used air after filtering and pushing the recycled air to the desired facility.

7) The air purification method according to claim 5 comprises passing the used air through HEPA filter/s after dehumidifying and before pushing into the desired facility.

8) An air purification system comprising:
a suction pump adapted to suck fresh air into a bed of liquid to absorb impurities;
a dehumidifier adapted to dehumidify the fresh air leaving the bed of liquid;
an AC plant adapted to push for sucking the fresh air from dehumidifier after dehumidification and to push the fresh air to a desired facility for being used by user/s of the facility; and
a ventilator adapted to ventilate out the used air from the desired facility.

9) An air purification system according to claim 8 comprises:
an HEPA filter for purifying the fresh air after dehumidifying the fresh air.

10) The air purification system according to claim 8 comprises
a ultra violet ray producer adapted to produce ultraviolet ray and to pass the ultraviolet rays through the fresh air through the AC plant before directing the fresh air to the desired facility.

11) The air purification method according to claim 8 comprises
a recycling unit adapted to receive used air after being ventilated out of the desired location and to filter the used air.

12) The air purification system according to claim 11, wherein the recycling unit is adapted to filter the used air by passing the used air through water mixed with chemicals.
